(19) United States
(12) Patent Application Publication
(10) Pub. No.: US 2003/0130086 A1
(43) Pub. Date: Jul. 10, 2003

(54) Toroidal-type continuously variable transmission

(75) Inventor: Kouji Ishikawa, Kanagawa (JP)

Correspondence Address: SUGHRUE MION, PLLC, 2100 PENNSYLVANIA AVENUE, N.W., WASHINGTON, DC, 20037, US

(73) Assignee: NSK Ltd.

(21) Appl. No.: 10/326,164

(22) Filed: Dec. 23, 2002

(30) Foreign Application Priority Data
Dec. 27, 2001 (JP) P. 2001-396016

(51) Int. Cl. F16H 15/38

(52) U.S. Cl. 476/40

(57) ABSTRACT

A toroidal-type continuously variable transmission has: a casing; a middle wall having a through hole; a plurality of support plates; a rotary shaft so as to be inserted through the through hole of the middle wall; a pair of first disks respectively including inner surfaces and respectively supported on the two end portions of the rotary shaft; a pair of second disks respectively including inner surfaces and respectively supported on the middle wall in the periphery of the middle portion of the rotary shaft; a plurality of trunnions respectively interposed between the inner surfaces of the first and second disks; a plurality of displacement shafts; a plurality of power rollers; a support bracket for supporting the support plates on the interior of the casing; and, a mounting portion fixedly formed in a portion of the support bracket for supporting and fixing the middle wall.

### BACKGROUND OF THE INVENTION

1. Field of the Invention

The present invention relates to an improvement in a toroidal-type continuously variable transmission which is used as a transmission unit for an automatic transmission for a vehicle.

2. Description of the Related Art

In part of the vehicle industry, as an automatic transmission for a vehicle, there is enforced such a toroidal-type continuously variable transmission as schematically shown in FIGS. 5 and 6. In this toroidal-type continuously variable transmission, for example, as disclosed in JP-UM-A-62-71465, an input side disk 2 is supported such that it is concentric with an input shaft 1, and an output side disk 4 is fixed to the end portion of an output shaft 3 which is disposed concentrically with the input shaft 1. Inside a casing 5, 5a (see FIGS. 8 and 9 which will be discussed later), there are disposed trunnions 7, 7 which can be swung about pivot shafts 6, 6 disposed at positions twisted with respect to the input shaft 1 and output shaft 3.

Each of the trunnions 7, 7 includes on the outer surfaces of the two end portions thereof a pair of pivot shafts 6, 6 in such a manner that the pair of pivot shafts 6, 6 are concentric with their respective trunnions 7, 7. The axes of the pivot shafts 6, 6 do not cross the axes of the disks 2, 4 but they exist at twisted positions which extend at right angles to the direction of the axes of the disks 2, 4 or at angles near to right angles. Also, on the central portions of the trunnions 7, 7, there are supported the base half portions of displacement shafts 8, 8; and thus, the inclination angles of the displacement shafts 8, 8 can be freely adjusted by swinging the trunnions 7, 7 about the pivot shafts 6, 6. On the peripheries of the front half portions of the displacement shafts 8, 8 supported on the trunnions 7, 7, there are supported power rollers 9, 9 in such a manner that they can be freely rotated. And, the power rollers 9, 9 are respectively held by and between the inner surfaces 2a, 4a of the input side and output side disks 2, 4.

The mutually opposed inner surfaces 2a, 4a of the input side and output side disks 2, 4 each has a section which is formed in an arc-shaped concave surface that can be obtained when an arc having the pivot shaft 6 as a center thereof or a curved line near to such arc is rotated. And, the peripheral surfaces 9a, 9a of the power rollers 9, 9, each of which is formed in a spherical-shaped convex surface, are contacted with the inner surfaces 2a, 4a. Also, between the input shaft 1 and input side disk 2, there is interposed a pressing device 10 such as a loading cam device; and, the pressing device 10, while elastically pressing the input side disk 2 toward the output side disk 4, is able to rotate the input side disk 2.

When the above-structured toroidal-type continuously variable transmission is in operation, as the input shaft 1 is rotated, the pressing device 10, while pressing the input side disk 2 against the plurality of power rollers 9, 9, rotates the input side disk 2. And, the rotational movement of the input side disk 2 is transmitted through the plurality of power rollers 9, 9 to the output side disk 4, with the result that the output shaft 3 fixed to the output side disk 4 is rotated.

Referring now to a case where the rotation speed between the input shaft 1 and output shaft 3 is changed, firstly, when the rotation speed is reduced between the input shaft 1 and output shaft 3, the trunnions 7, 7 are swung about their respective pivot shafts 6, 6 to thereby incline the displacement shafts 8, 8 in such a manner that, as shown in FIG. 5, the peripheral surfaces 9a, 9a of the power rollers 9, 9 can be respectively contacted with the near-to-center portion of the inner surface 2a of the input side disk 2 and the near-to-outer-periphery portion of the inner surface 4a of the output side disk 4.

On the other hand, when increasing the rotation speed, the trunnions 7, 7 are swung to thereby incline the displacement shafts 8, 8 in such a manner that, as shown in FIG. 6, the peripheral surfaces 9a, 9a of the power rollers 9, 9 can be respectively contacted with the near-to-outer-periphery portion of the inner surface 2a of the input side disk 2 and the near-to-center portion of the inner surface 4a of the output side disk 4. Also, in case where the inclination angles of the displacement shafts 8, 8 are set intermediate between FIGS. 5 and 6, there can be obtained an intermediate transmission ratio between the input shaft 1 and output shaft 3.

Further, FIGS. 7 and 8 show a toroidal-type continuously variable transmission disclosed in JP-UM-A-1-173552, which is a more specific version of the previously discussed conventional toroidal-type continuously variable transmission. In this toroidal-type continuously variable transmission, an input side disk 2 and an output side disk 4 are respectively supported on the periphery of a circular-pipe-shaped input shaft 1 in such a manner that both disks 2 and 4 can be freely rotated. Also, between the end portion of the input shaft 11 and the input side disk 2, there is interposed a pressing device 10. On the other hand, to the output side disk 4, there is connected an output gear 12, so that the output disk 4 and output gear 12 can be rotated in synchronization with each other.

On the two end portions of each of a pair of trunnions 7, 7, there are disposed pivot shafts 6, 6 in such a manner that they are concentric with their respective trunnions 7, 7. The pivot shafts 6, 6 are supported on a pair of support plates (yokes) 13, 13 in such a manner that they can be swung as well as can be shifted in the axial direction thereof (that is, in FIG. 7, in the front and rear direction of the sheet of FIG. 7; and, in FIG. 8, in the vertical direction thereof). And, on the middle portions of the trunnions 7, 7, there are respectively supported the base half portions of a pair of displacement shafts 8, 8. The displacement shafts 8, 8 are structured such that the base half portions thereof are eccentric to the front half portions thereof. Also, the base half portions of the displacement shafts 8, 8 are respectively supported on the middle portions of the trunnions 7, 7 so as to be rotatable, while the power rollers 9, 9 are respectively supported on the front half portions of the displacement shafts 8, 8 so as to be rotatable.

By the way, the pair of displacement shafts 8, 8 are disposed at positions which exist on the 180° opposite side to the input shaft 11. Also, the direction, in which the base half portions of the displacement shafts 8, 8 are eccentric to the front half portions thereof, is set to be the same direction (in FIG. 8, in the reversed vertical direction) with respect to rotation direction of the input side and output side disks 2, 4. And, this eccentric direction is set to be a direction which intersects almost at right angles to the arrangement direction of the input shaft 11. Therefore, the power rollers 9, 9 are respectively supported in such a manner that they can be slightly shifted with respect to the arrangement direction of the input shaft 11.

Also, between the outer surfaces of the power rollers 9, 9 and the inner surfaces of the middle portions of the trunnions 7, 7, there are interposed thrust ball bearings 14, 14 and thrust needle roller bearings 15, 15 in the order starting from the outer surfaces of the power rollers 9, 9. Out of them, the thrust ball bearings 14, 14, while supporting thrust-direction loads applied to the power rollers 9, 9, allow the power rollers 9, 9 to rotate. And, the thrust needle roller bearings 15, 15, while supporting thrust loads applied from the power rollers 9, 9 to outer races 16, 16 respectively constituting the thrust ball bearings 14, 14, allow the front half portions of the displacement shafts 8, 8 and the outer races 16, 16 to be swung about the base half portions of the displacement shafts 8, 8. Further, the trunnions 7, 7 can be freely shifted in the axial directions of their associated pivot shafts 6, 6 by actuators (oil-pressure cylinders) 17, 17 each of an oil pressure type.

In the case of the above-structured toroidal-type continuously variable transmission, the rotational movement of the input shaft 11 is transmitted through the pressing device 10 to the input side disk 2. And, the rotational movement of the input side disk 2 is transmitted through the pair of power rollers 9, 9 to the output side disk 4, and further the rotational movement of the output side disk 4 is taken out by the output gear 12.

When changing the rotation speed ratio between the input shaft 11 and output gear 12, the pair of trunnions 7, 7 are respectively shifted by the actuators 17, 17 in the mutually opposite directions in such a manner that, for example, the power roller 9 situated on the right side in FIG. 8 is shifted to the lower side in FIG. 8 and the power roller 9 on the left side in FIG. 8 is shifted to the upper side in FIG. 8. As a result of this, the direction of a tangential-direction force, which acts on the contact portion between the peripheral surfaces 9a, 9a of the power rollers 9, 9 and the inner surfaces 2a, 4a of the input side and output side disks 2, 4, is caused to vary (that is, there occurs side slippage in the contact portion). And, as the tangential-direction force is varied, the trunnions 7, 7 are swung in the mutually opposite directions about the pivot shafts 6, 6 pivotally supported inside circular holes 18, 18 formed in the support plates 13, 13 by radial needle roller bearings 19, 19. Due to this, as previously shown in FIGS. 5 and 6, the contact positions between the peripheral surfaces 9a, 9a of the power rollers 9, 9 and the inner surfaces 2a, 4a of the input side and output side disks 2, 4 are changed to thereby change the rotation speed ratio between the input shaft 11 and output gear 12. By the way, the outer peripheral surfaces of outer races 20, which respectively constitute the radial needle roller bearings 19, 19, are respectively formed in a spherical-shaped convex surface, thereby allowing the pivot shafts 6, 6 to be swingably shifted with respect to the support plates 13, 13.

Supply of pressure oil to the actuators 17, 17 can be controlled by a single control valve regardless of the number of actuators 17, 17, while feedback on the movement of any one of the trunnions 7 can be given to the control valve. While the structure of this portion is disclosed, for example, in U.S. Pat. No. 5,464,375 and is conventionally known, description will be given here briefly of the structure of this portion with reference to FIG. 11 which shows a second example of conventional concrete structures to be discussed later. That is, in FIG. 11, a control valve 21 includes a sleeve 23 to be shifted in the axial direction (in FIG. 11, in the right and left direction) by a stepping motor 22 and a spool 24 mounted on the inside diameter side of the sleeve 23 in such a manner that it can be shifted in the axial direction. A precess cam 26 is fixed to the end portion of a rod 25 which belongs to any one of the trunnions 7, 7. In this manner, there is formed a feedback mechanism which is used to transmit the motion of the rod 25 to the spool 24 through the precess cam 26 and a link arm 27.

To switch the transmission state over to another one, the sleeve 23 may be shifted by a given amount using the stepping motor 22 to thereby open the flow passage of the control valve 21. As a result of this, the pressure oil is fed into the actuators 17, 17 in a given direction, so that the actuators 17, 17 shift the trunnions 7, 7 in the given direction. That is, as the pressure oil is fed into the actuators 17, 17, the trunnions 7, 7, while being shifted in the axial directions of their respective pivot shafts 6, 6, are swung about their respective pivot shafts 6, 6. And, the motion (the axial-direction shifting movement and swing shifting movement) of any one of the trunnions 7 is transmitted to the spool 24 through the precess cam 26 fixed to the end portion of a rod 25 and through the link arm 27, thereby shifting the spool 24 in the axial direction. Due to this, in a state where the trunnion 7 is shifted by a given amount, the flow passage of the control valve 21 is closed to thereby stop the supply of the pressure oil to the respective actuators 17, 17. Therefore, the shift amounts of the trunnions 7, 7 in the axial direction and in the swing direction thereof correspond to the shift amount of the sleeve 23 shifted by the stepping motor 22.

By the way, while the toroidal-type continuously variable transmission is transmitting power, due to the elastic deformation of the composing parts of the toroidal-type continuously variable transmission, the power rollers 9, 9 are shifted in the axial direction of the input shaft 11 (FIGS. 7 and 8). And, the displacement shafts 8, 8 supporting these power rollers 9, 9 are slightly rotated about their respective base half portions. As a result of such rotation, the outer surfaces of the outer races 16, 16 of the thrust ball bearings 14, 14 and the inner surfaces of the trunnions 7, 7 are shifted with respect to each other. Because the thrust needle roller bearings 15, 15 are present between these outer surfaces and inner surfaces, a force necessary for such relative shifting motion is small.

Further, conventionally, there is also known a structure of a so called double cavity type in which, in order to increase the torque that can be transmitted, as shown in FIGS. 9 to 11, on the periphery of an input shaft 11a, there are disposed input side disks 2A, 2B and output side disks 4, 4 each by twos, and the two input side disks 2A, 2B and two output side disks 4, 4 are disposed in parallel to each other with respect to the power transmission direction. In the structure shown in FIGS. 9 to 11, an output gear 12a is supported on the periphery of the middle portion of the input shaft 11a in such a manner that it can be rotated with respect to the input shaft 11a, while the output side disks 4, 4 are respectively spline engaged with the two end portions of a cylinder portion 28 which is disposed on the central portion of the output gear 12a.

In order to be able to support the output gear 12a and cylinder portion 28 on the periphery of the input shaft 11a in such a manner that they can be rotated, a middle wall 29 is fixedly disposed on the interior of a casing 5a. The input shaft 11a is rotatably supported on the interior of the casing 5a in such a manner that it is inserted through a through hole 30 formed in the middle wall 29. The cylinder portion 28 is rotatably supported on the inside diameter side of the through hole 30 by a pair of rolling bearings 31, 31 like an angular contact type ball bearing which consists of a front-to-front combination. And, in this state, the output gear 12a is rotatably stored within the middle wall 29 which is formed hollow. Also, between the inner peripheral surfaces of the inner-surface-side half portions of the two output side disks 4, 4 and the outer peripheral surface of the input shaft 11a, there are interposed radial needle roller bearings 32, 32, respectively.

Also, the input side disks 2A, 2B are respectively supported on the two end portions of the input shaft 11a in such a manner that they can be rotated in synchronization with the input shaft 11a. The input shaft 11a can be driven and rotated by a drive shaft 51 through a pressing device 10 of a loading cam type. In such rotational driving, the input side disk 2A on the pressing device 10 side, while it is pressed toward the input side disk 2B on the opposite side, is rotated in synchronization with the input side disk 2B. For this purpose, the input side disks 2A, 2B are respectively supported on the two end portions of the input shaft 11a through ball splines 33. Also, between the input shaft 11a and the above-mentioned input side disks. 2A, 2B, there is interposed a preload mechanism which includes a loading nut 34 and countersunk plate springs 35a, 35b; and thus, even when the pressing device 10 is not in operation, there can be secured a surface pressure in the contact portions between the inner surfaces 2a, 4a of the respective disks 2A, 2B, 4 and the peripheral surfaces 9a, 9a of the power rollers 9, 9.

In the case of the toroidal-type continuously variable transmission of the above-mentioned double cavity type, transmission of the power from the input shaft 11a to the output gear 12a is carried out through two divided systems, that is, one system between one-side input side disk 2A and output side disk 4 and the other system between the-other-side input side disk 2B and output side disk 4; and, therefore, large power transmission is possible. By the way, in the case of the toroidal-type continuously variable transmission of the above-mentioned double cavity type as well, in the gear change operation, the trunnions 7, 7 are shifted in the axial direction of the pivot shafts 6, 6 using the oil-pressure type actuators 17, 17. Referring to a control valve 21 which is used to control supply of the pressure oil to the actuators 17, 17 for gear change, as described before, there is disposed only one control valve in the whole of the toroidal-type continuously variable transmission. And, using this single control valve 21, supply of the pressure oil to the plurality of actuators 17, 17 is controlled.

In order to structure a toroidal-type continuously variable transmission of the above-mentioned double cavity type, conventionally, the support plates 13, 13 for supporting the trunnions 7, 7 and the middle wall 29 for supporting the output side disks 4, 4 and output gear 12a are supported on the casing 5a in such a manner that they are independent of each other. That is, the support plates 13, 13 are slightly shiftably supported on the interior of the casing 5a through support posts 36a, 36b. On the other hand, the middle wall 29 is connected and fixed to the interior of the casing 5a through a mounting piece 37. The mounting piece 37 and support posts 36a, 36b are respectively connected and fixed to the inner surface of the casing 5a in such a manner that they are independent of each other.

In the above-mentioned conventional structures, the dimensional precision of the respective composing parts thereof must be restricted strictly, which results in the expensive manufacturing cost thereof. The reason for this is as follows.

That is, in order to be able to maintain the proper contact state between the peripheral surfaces 9a, 9a of the power rollers 9, 9 supported on the support plates 13, 13 through the trunnions 7, 7 and the inner surfaces 4a, 4a of the output disks 4, 4 supported on the middle wall 29, the position relationship between the support plates 13, 13 and middle wall 29 must be restricted strictly. On the other hand, as in the above-mentioned conventional structures, in case where the mounting piece 37 for fixing the middle wall 29 and the support posts 36a, 36b for supporting the support plates 13, 13 are connected and fixed to the inner surface of the casing 5a independently of each other, unless the respective composing parts of the conventional structures are finished with rather high precision, it is difficult to secure the precision that is necessary for the proper position relationship between the support plates 13, 13 and middle wall 29. Thus, the respective composing parts of the conventional structures must be finished with rather high precision, which results in the increased manufacturing costs of the composing parts.

### SUMMARY OF THE INVENTION

The present invention aims at eliminating the drawbacks found in the above-mentioned conventional toroidal-type continuously variable transmissions. Accordingly, it is an object of the present invention to provide an improved toroidal-type continuously variable transmission.

In attaining the above object, according to a first aspect of the present invention, there is provided a toroidal-type continuously variable transmission, comprising: a casing; a middle wall disposed in the interior of the casing and having a through hole; a plurality of support plates disposed in the interior of the casing; a rotary shaft rotatably supported on the interior of the casing so as to be inserted through the through hole of the middle wall; a pair of first disks respectively including inner surfaces each formed as a concave surface having an arc-shaped section and respectively supported on the two end portions of the rotary shaft in such a manner that their respective inner surfaces are opposed to each other so as to be rotated in synchronization with the rotary shaft; a pair of second disks respectively including inner surfaces each formed as a concave surface having an arc-shaped section and respectively supported on the middle wall in the periphery of the middle portion of the rotary shaft in such a manner that their inner surfaces are opposed to the inner surfaces of the first disks so as to be rotated relatively with respect to the rotary shaft and rotated in synchronization with each other; a plurality of trunnions respectively interposed between the inner surfaces of the first and second disks so as to be swung about pivot shafts existing at twisted positions with respect to the rotary shaft and pivotally supported on the support plates; a plurality of displacement shafts disposed so as to project from the inner surfaces of the trunnions; a plurality of power rollers respectively including peripheral surfaces formed as spherical-shaped convex surfaces and supported on the inner surfaces of the trunnions so as to be rotatable about the displacement shafts, the peripheral surfaces of the power rollers being contacted with the inner surface of the first and second disks; a support bracket for supporting the support plates on the interior of the casing; and, a mounting portion fixedly formed in a portion of the support bracket for supporting and fixing the middle wall.

In the above construction, it is preferable that the middle wall is connected and fixed to the mounting portion in such a manner that the middle wall is superimposed on two surfaces of the mounting portion in the axial direction of the rotary shaft.

According to a second aspect of the present invention, there is provided a toroidal-type continuously variable transmission, comprising: a casing; a middle wall disposed in the interior of the casing and having a through hole; a plurality of support plates disposed in the interior of the casing; a plurality of support posts respectively for supporting the support plates; a support bracket for supporting the support plates on the casing through the support posts; a rotary shaft rotatably supported on the interior of the casing so as to be inserted through the through hole of the middle wall; a pair of first disks respectively including inner surfaces each formed as a concave surface having an arc-shaped section and respectively supported on the two end portions of the rotary shaft in such a manner that their respective inner surfaces are opposed to each other so as to be rotated in synchronization with the rotary shaft; a pair of second disks respectively including inner surfaces each formed as a concave surface having an arc-shaped section and respectively supported on the middle wall in the periphery of the middle portion of the rotary shaft in such a manner that their inner surfaces are opposed to the inner surfaces of the first disks so as to be rotated relatively with respect to the rotary shaft and rotated in synchronization with each other; a plurality of trunnions respectively interposed between the inner surfaces of the first and second disks so as to be swung about pivot shafts existing at twisted positions with respect to the rotary shaft and pivotally supported on the support plates; a plurality of displacement shafts disposed so as to project from the inner surfaces of the trunnions; a plurality of power rollers respectively including peripheral surfaces formed as spherical-shaped convex surfaces and supported on the inner surfaces of the trunnions so as to be rotatable about the displacement shafts, the peripheral surfaces of the power rollers being contacted with the inner surface of the first and second disks; and a mounting portion fixedly formed in a portion of the support bracket for supporting and fixing the middle wall.

In the above-structured toroidal-type continuously variable transmission according to the present invention, the operation for transmitting power between an input part and an output part and the operation for changing a gear change ratio between the input and output parts are respectively similar to the previously-described conventional toroidal-type continuously variable transmissions.

Especially, in the case of the toroidal-type continuously variable transmission of the present invention, since the support plates and middle wall are supported on the casing using a single support bracket, even in case where the finishing precision of the respective parts is not excessively high, there can be secured the precision that is necessary to maintain the proper position relationship between the support plates and middle wall.

### BRIEF DESCRIPTION OF THE DRAWINGS

FIG. 1 is a sectional view showing an embodiment of a toroidal-type continuously variable transmission according to the present invention in a state that a transmission unit is disposed in a casing;

FIG. 2 is a sectional view concerning to upper portion shown in FIG. 1 in a state that the sectional portion is shifted in a front and back direction of FIG. 1;

FIG. 3 is A-A sectional view of FIG. 2 omitted a part thereof;

FIG. 4 is a sectional view of the transmission unit before disposing into the casing;

FIG. 5 is a basic structure of the toroidal-type continuously variable transmission in a maximum deceleration state;

FIG. 6 is a basic structure of the toroidal-type continuously variable transmission in a maximum acceleration state;

FIG. 7 is a sectional view of a relevant part showing a first embodiment of a concrete structure of the toroidal-type continuously variable transmission;

FIG. 8 is a B-B sectional view of FIG. 7;

FIG. 9 is a sectional view of a relevant part showing a second embodiment of a concrete structure of the toroidal-type continuously variable transmission;

FIG. 10 is a C-C sectional view of FIG. 9; and

FIG. 11 is a D-D sectional view of FIG. 9.

### DETAILED DESCRIPTION OF THE PREFERRED EMBODIMENTS

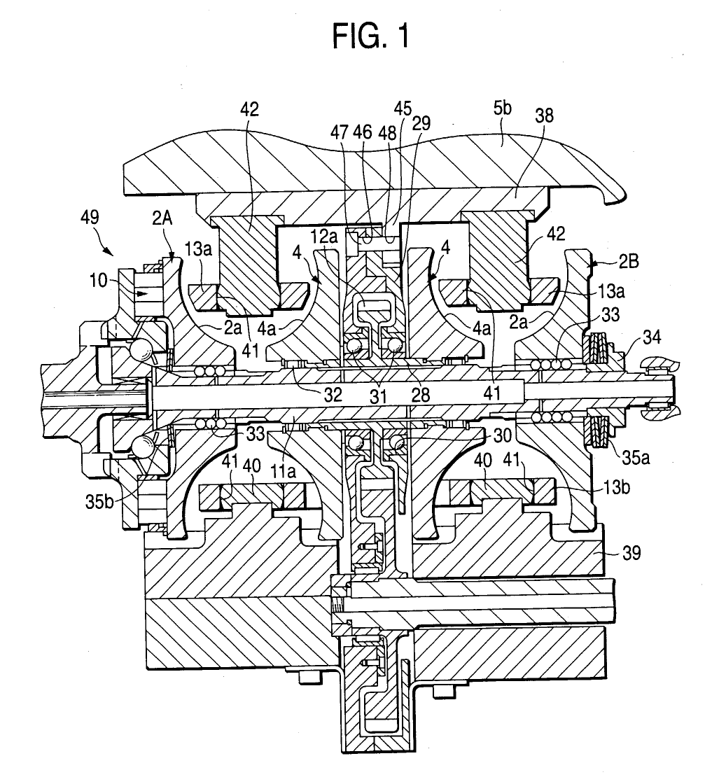

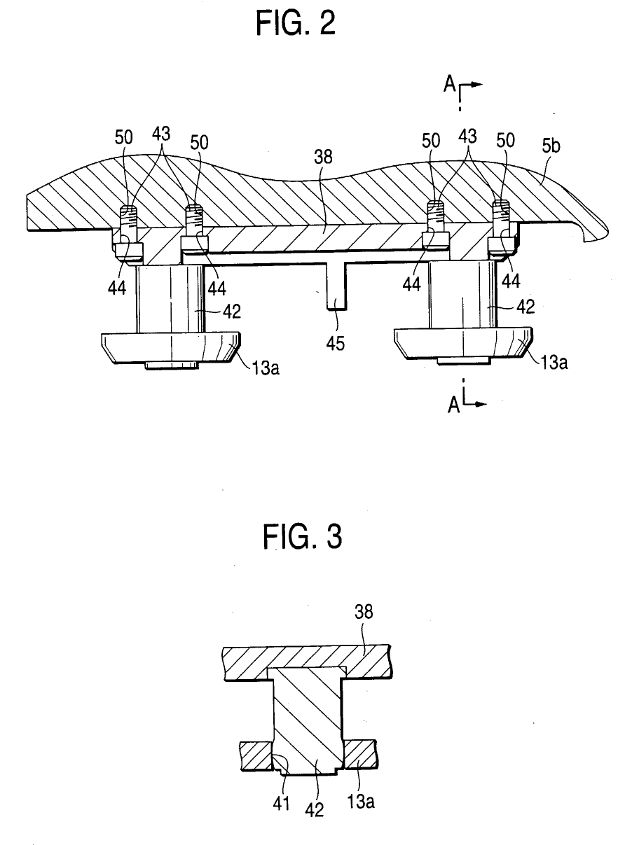

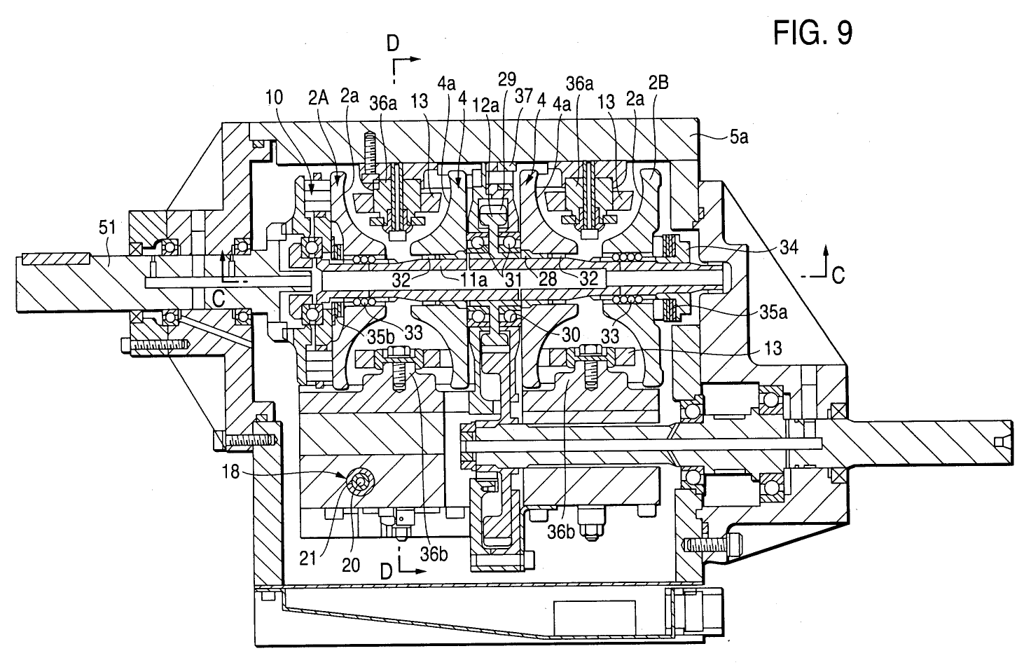

Now, FIGS. 1 to 4 show an embodiment of a toroidal-type continuously variable transmission according to the present invention. By the way, the present invention is characterized in that, in order to be able to enhance precision with respect to the position relationship between support plates 13a, 13a and middle wall 29, the support plates 13a, 13a and middle wall 29 are supported on a casing 5b using a single support bracket 38. The remaining structures and operations of the present invention are almost similar to the second example of the conventional concrete structures previously shown in FIGS. 9 to 11. Therefore, the illustration and description of the equivalent portions are omitted or simplified and thus description will be given below mainly of the characteristic portions of the present invention.

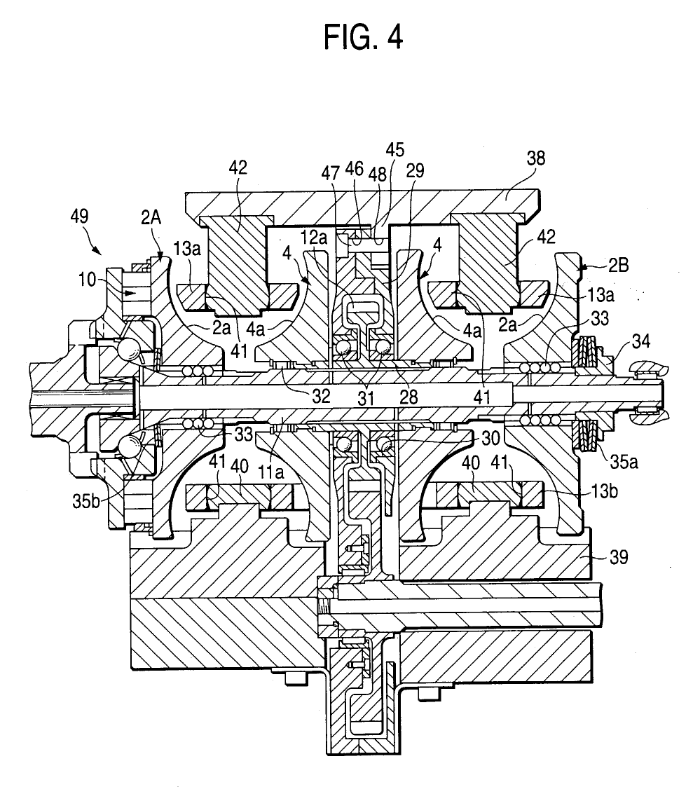

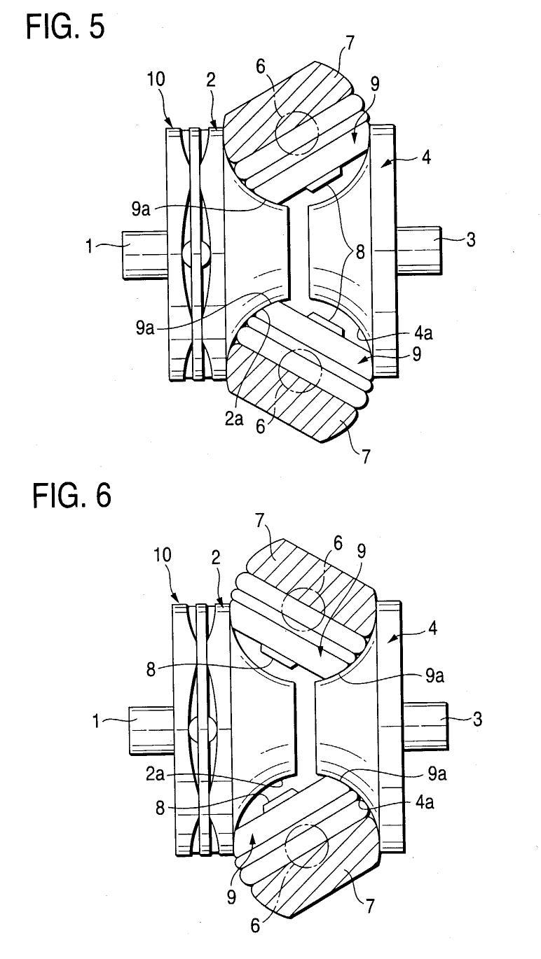

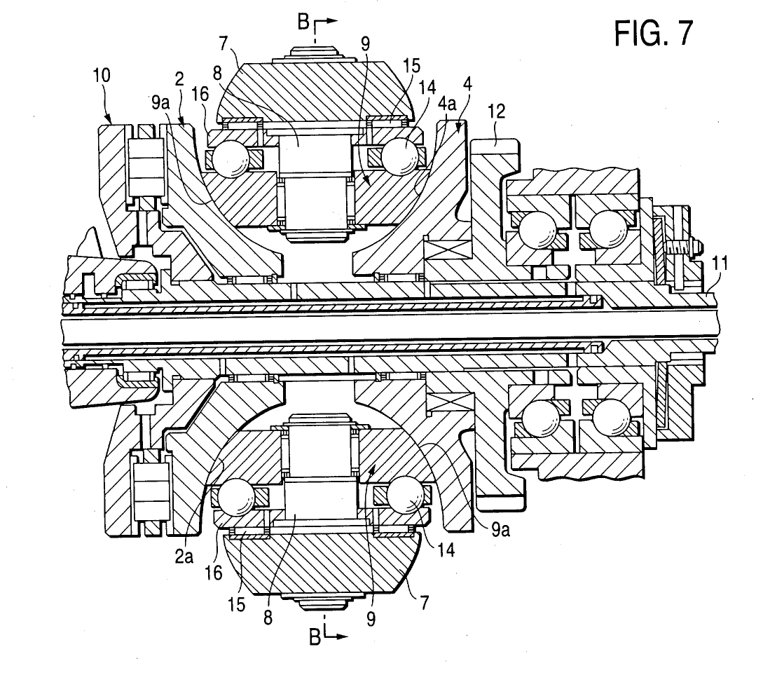

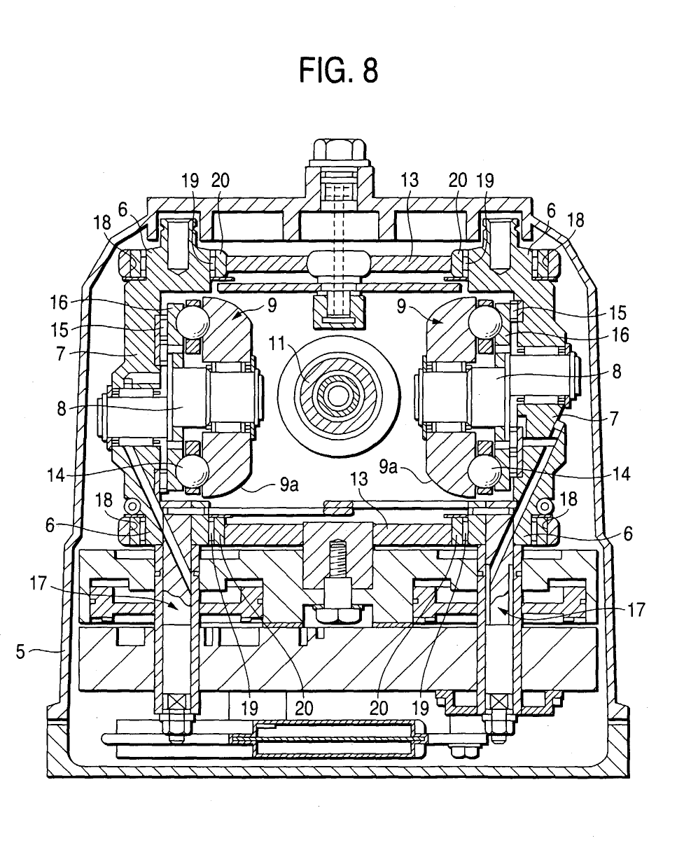

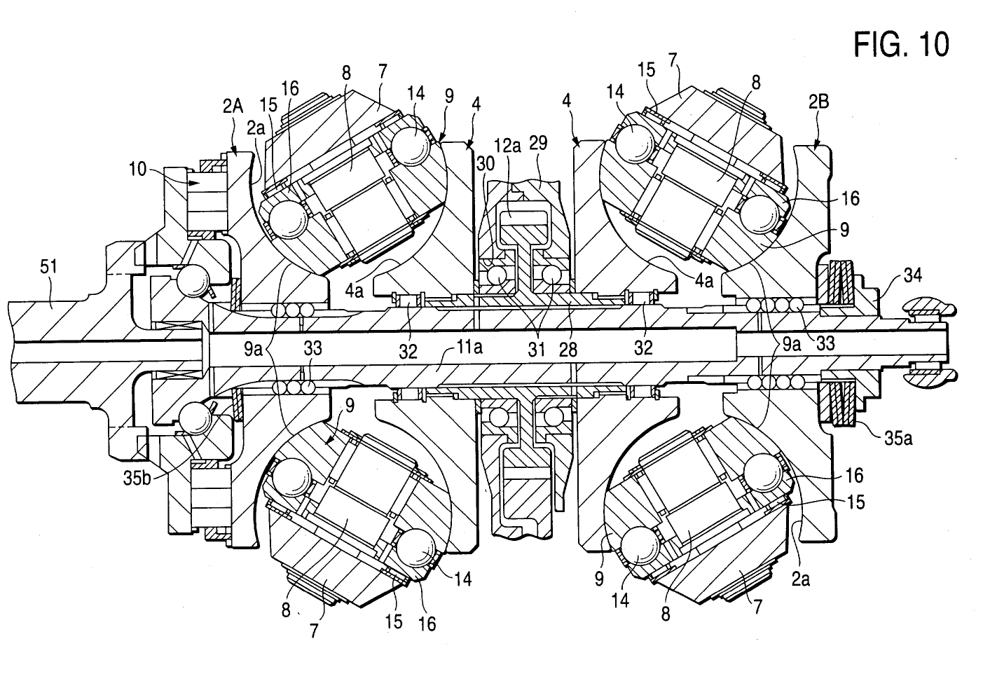

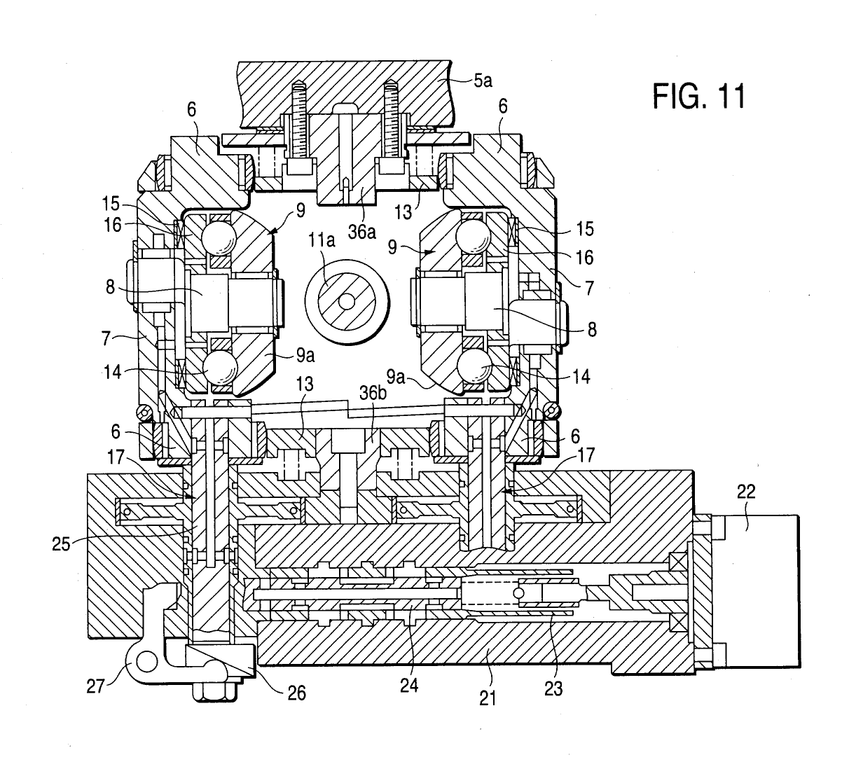

In a continuously variable transmission according to the present invention, of a plurality of support plates 13a, 13b for supporting the two end portions of the respective trunnions 7, 7 (see FIGS. 10 and 11), the one-side (in FIGS. 1 and 4, upwardly situated) support plates 13a, 13a are respectively supported on the casing 5b by the support bracket 38 which is a characteristic element of the present invention. On the other hand, the other-side (in FIGS. 1 and 4, downwardly situated) support plate 13b, similarly to the above-mentioned second example of the conventional concrete structures, are supported on the casing 5b respectively through support posts 40, 40 fixed to a valve case 39 constituting a control valve 21 (see FIG. 11).

By the way, of the plurality of support plates 13a, 13b that are incorporated into a toroidal-type continuously variable transmission of a double cavity type according to the present invention, the other-side support plate 13b are respectively formed in a square-frame-like shape. And, the width-direction (that is, in FIGS. 1, 2 and 4, the front and back direction of the sheets thereof) central portions of the sides of the longitudinal-direction (that is, the axial direction of the input shaft; in FIGS. 1, 2 and 4, the right and left direction thereof) two end sides of each of the support plate 13b are supported on the casing 5b in such a manner that they can be slightly shifted. For this purpose, in the width-direction central portions of the sides of the longitudinal-direction two end sides of the support plate 13b, there are formed circular holes 41, 41 respectively; and, into these circular holes 41, 41, there are fitted the portions of the leading end portions of the support posts 40, 40 whose outer peripheral surfaces are formed as spherical-shaped convex surfaces. The shapes of the support plate 13b are basically the same as those of the second example of the conventional concrete structures previously shown in FIGS. 9 to 11 and are conventionally known in many publications. Therefore, the detailed illustration and description thereof are omitted here. On the other hand, in the case of the illustrated embodiment, the one-side support plates 13a, 13a are disposed independently by twos in each of cavities (that is, the portions that exist between the input side disks 2A, 2B and output side disks 4, 4 with their respective inner surfaces 2a, 4a opposed to each other). And, into another circular holes 41, 41 which are formed in the middle portions of the support plates 13a, 13a, there are fitted the portions of the leading end portions of support posts 42, 42 whose outer peripheral surfaces are formed as spherical-shaped convex surfaces. By the way, in the case of the one-side support plates 13a, 13a as well, similarly to the other-side support plate 13b, in many cases, there are used support plates each of which is formed in a square-frame-shaped unified plate. These support plates 13a, 13a are also basically the same in shape as the second example of the conventional concrete structures previously shown in FIGS. 9 to 11 and are conventionally known in many publications. Therefore, the detailed illustration and description thereof are omitted here.

Especially, in the case of the continuously variable transmission of the present invention, the one-side support plates 13a and middle wall 29 are respectively supported on the casing 5b by the above-mentioned single support bracket 38. In order to connect and fix the support bracket 38 to the casing 5b, in the four corner portions of the support bracket 38, there are formed through holes 44, 44 through which screws 43, 43 for connection and fixation of the support bracket 38 can be inserted. Also, in order to support the support plates 13a on the support bracket 38, the base end portions of support posts 42, 42 are respectively fitted with and fixed to the width-direction central portions of the longitudinal-direction two end portions of the support bracket 38 by close fit. Further, so as to support and fix the middle wall 29 onto the support bracket 38, on the longitudinal-direction middle portion of the support bracket 38, there is projectingly formed a mounting portion 45. For the purpose of formation of the mounting portion 45 on the support bracket 38, the shape of the portion of the inner surface of the casing 5b, to which the middle wall 29 is to be connected and fixed, is formed as a simple surface (that is, a simply flat surface).

To support and fix the middle wall 29 onto the interior of the casing 5b, a screw 47, which is inserted through a mounting hole 46 formed in the near-to-outer-periphery end portion of the middle wall 29 so as to extend in the axial direction of the input shaft 11a, may be threadedly engaged into a screw hole 48 formed in the mounting portion 45 and then may be tightened further. In this state, the near-to-outer-periphery end portion of the middle wall 29 is connected and fixed to the mounting portion 45 in such a manner that the end portion is superimposed on the mounting portion in the axial direction of the input shaft 11a. Due to this, the support rigidity of the middle portion 29 with respect to the support bracket 38 can be enhanced sufficiently. On the other hand, the leading end portions of the support posts 42, 42 may be fitted the inner surfaces of the circular holes 41, 41 formed in the middle portions of-the support plates 13a, 13a which are used to support the one-end portions (in FIGS. 1 and 4, the upper end portions) of the trunnions 7, 7. In this state, the middle wall 29 and support plates 13a, 13aare combined together with a proper position relationship maintained between them.

By the way, the operation for assembling the middle wall 29 and support plates 13a, 13a to the support bracket 38 is carried out before the support bracket 38 is fixed onto the interior of the casing 5b. In this manner, there can be constructed such a transmission unit 49 as shown in FIG. 4, including the support bracket 38, middle wall 29 and support plates 13a, 13a. Assembly of the transmission unit 49 can be executed in a wide space which is not surrounded by the casing 5b. Therefore, when compared with a structure in which the middle wall 29 is assembled directly to the interior of the casing 5a such as the conventional structure previously shown in FIG. 9, according to the present invention, the assembling operation can be facilitated. Also, in a state where the transmission unit 49 has been assembled, it is possible to confirm whether the operations of the respective composing parts including the position relationships between the mutually associated composing parts are good or not. Thanks to this, the operation for taking the transmission unit 49 to pieces and reassembling it, which is required in case where the operations of the composing parts of the transmission unit 49 are not good, can be facilitated.

The transmission unit 49, which has been assembled in such a manner as shown in FIG. 4, is then inserted into the casing 5b. Next, the screws 43, 43, which have been inserted through the through holes 44, 44 formed in the four corner portions of the support bracket 38, are threadedly engaged with screw holes 50, 50 formed in the inner surface of the casing 5b and are then tightened further to thereby fix the support bracket 38 to the casing 5b. In this state, the transmission unit 49 is installed within the casing 5b. By the way, when installing the transmission unit 49 into the casing 5b, the valve case 39 is separately supported and fixed to the interior of the casing 5b with a proper position relationship maintained between them. The precision of this portion can be secured in a similar manner to the above-mentioned conventional structure.

In the case of the above-structured toroidal-type continuously variable transmission of the present invention, the support plates 13a, 13a and middle wall 29 are all supported on the casing 5b by the single support bracket 38. This can facilitate the operation for restricting properly the position relationship between the support plates 13a, 13a and middle wall 29. As a result of this, even in case where the precision of the respective composing parts are not enhanced excessively, it is possible to secure the precision that is necessary to maintain a proper position relationship between the support plates 13a, 13a and middle wall 29.

Since the present invention is structured and operated in the above-mentioned manner, a toroidal-type continuously variable transmission, which is excellent in precision and transmission efficiency, can be realized at a low cost.

What is claimed is:

1. A toroidal-type continuously variable transmission, comprising:
a casing;
a middle wall disposed in the interior of the casing and having a through hole;
a plurality of support plates disposed in the interior of the casing;
a rotary shaft rotatably supported on the interior of the casing so as to be inserted through the through hole of the middle wall;
a pair of first disks respectively including inner surfaces each formed as a concave surface having an arc-shaped section and respectively supported on the two end portions of the rotary shaft in such a manner that their respective inner surfaces are opposed to each other so as to be rotated in synchronization with the rotary shaft;
a pair of second disks respectively including inner surfaces each formed as a concave surface having an arc-shaped section and respectively supported on the middle wall in the periphery of the middle portion of the rotary shaft in such a manner that their inner surfaces are opposed to the inner surfaces of the first disks so as to be rotated relatively with respect to the rotary shaft and rotated in synchronization with each other;
a plurality of trunnions respectively interposed between the inner surfaces of the first and second disks so as to be swung about pivot shafts existing at twisted positions with respect to the rotary shaft and pivotally supported on the support plates;
a plurality of displacement shafts disposed so as to project from the inner surfaces of the trunnions;
a plurality of power rollers respectively including peripheral surfaces formed as spherical-shaped convex surfaces and supported on the inner surfaces of the trunnions so as to be rotatable about the displacement shafts, the peripheral surfaces of the power rollers being contacted with the inner surface of the first and second disks;
a support bracket for supporting the support plates on the interior of the casing; and,
a mounting portion fixedly formed in a portion of the support bracket for supporting and fixing the middle wall.

2. The toroidal-type continuously variable transmission as set forth in claim 1, wherein the middle wall is connected and fixed to the mounting portion in such a manner that the middle wall is superimposed on two surfaces of the mounting portion in the axial direction of the rotary shaft.

3. A toroidal-type continuously variable transmission, comprising:
a casing;
a middle wall disposed in the interior of the casing and having a through hole;
a plurality of support plates disposed in the interior of the casing;
a plurality of support posts respectively for supporting the support plates;
a support bracket for supporting the support plates on the casing through the support posts;
a rotary shaft rotatably supported on the interior of the casing so as to be inserted through the through hole of the middle wall;
a pair of first disks respectively including inner surfaces each formed as a concave surface having an arc-shaped section and respectively supported on the two end portions of the rotary shaft in such a manner that their respective inner surfaces are opposed to each other so as to be rotated in synchronization with the rotary shaft;
a pair of second disks respectively including inner surfaces each formed as a concave surface having an arc-shaped section and respectively supported on the middle wall in the periphery of the middle portion of the rotary shaft in such a manner that their inner surfaces are opposed to the inner surfaces of the first disks so as to be rotated relatively with respect to the rotary shaft and rotated in synchronization with each other;
a plurality of trunnions respectively interposed between the inner surfaces of the first and second disks so as to be swung about pivot shafts existing at twisted positions with respect to the rotary shaft and pivotally supported on the support plates;
a plurality of displacement shafts disposed so as to project from the inner surfaces of the trunnions;
a plurality of power rollers respectively including peripheral surfaces formed as spherical-shaped convex surfaces and supported on the inner surfaces of the trunnions so as to be rotatable about the displacement shafts, the peripheral surfaces of the power rollers being contacted with the inner surface of the first and second disks; and
a mounting portion fixedly formed in a portion of the support bracket for supporting and fixing the middle wall.
